(19) United States
(12) Patent Application Publication
(10) Pub. No.: US 2016/0086365 A1
(43) Pub. Date: Mar. 24, 2016

(54) SYSTEMS AND METHODS FOR THE CONVERSION OF IMAGES INTO PERSONALIZED ANIMATIONS

(71) Applicants: Stephane PETTI, London (GB); Matthew LOUIS, Boca Raton, FL (US); Giancarlo MANNUCCIA, London (GB)

(72) Inventors: Stephane PETTI, London (GB); Matthew LOUIS, Boca Raton, FL (US); Giancarlo MANNUCCIA, London (GB)

(73) Assignee: Weboloco Limited, ILFORD (GB)

(21) Appl. No.: 14/858,438

(22) Filed: Sep. 18, 2015

Related U.S. Application Data
(60) Provisional application No. 62/052,809, filed on Sep. 19, 2014.

(51) Int. Cl. G06T 13/00; G06T 3/00; G06T 11/60; G06K 9/46; G06T 7/20

(52) U.S. Cl. CPC G06T 13/00; G06K 9/4671; G06T 7/2033; G06T 11/60; G06T 3/00; G06T 2213/08

(57) ABSTRACT

Systems and methods for converting an image into an animated image or video, including: an algorithm for receiving the image from a user via an electronic device; an algorithm for applying a selected template to the image, wherein the selected template imparts selected portions of the image with motion or overlays selected objects on the image, thereby providing an animated image or video; and an algorithm for displaying the animated image or video to the user via the electronic device. The applying the selected template to the image is performed by software resident on the electronic device or remote from the electronic device.

### CROSS-REFERENCE TO RELATED APPLICATION

The present patent application/patent claims the benefit of priority of co-pending U.S. Provisional Patent Application No. 62/052,809, filed on Sep. 19, 2014, and entitled “SYSTEMS AND METHODS FOR THE CONVERSION OF IMAGES INTO PERSONALIZED ANIMATIONS,” the contents of which are incorporated in full by reference herein.

### FIELD OF THE INVENTION

The present invention relates generally to a software application that is either embedded within a device, such as a personal computer (PC), a tablet computer, a smartphone, or the like, that is web-based and resides on a web server or the like and is accessible through a website or the like, or that is accessible through a cloud-based network or the like. More specifically, the present invention relates to systems and methods for the conversion of images into personalized animations, such as videos, animated GIFs, or the like.

### BACKGROUND OF THE INVENTION

In a variety of social, entertainment, and professional settings it would be desirable and profitable to allow a user to convert a still two-dimensional (2D) or three-dimensional (3D) picture or image into a personalized 2D or 3D animation or video, thereby bringing “life” to the picture or image in a comical or meaningful way. Ideally, sound and/or other graphical objects could also be incorporated. In other words, parts of a picture or image could be animated to create realistic or unrealistic motion, etc. Various “stories” could also be applied to the picture or image via the selection and incorporation of various templates, for example. Advantageously, such functionality is provided by the systems and methods of the present invention.

### BRIEF SUMMARY OF THE INVENTION

In various exemplary embodiments, the present invention provides an automated process that transforms still 2D or 3D pictures or images into personalized 2D or 3D animations or videos. Sound and/or other graphical objects may also be incorporated. Parts of the pictures or images are animated to create realistic or unrealistic motion (e.g., realistic human motion may be applied to an inanimate object or unrealistic motion may be applied to an animate object, among other possibilities). Various “stories” may be also applied to the pictures or images via the selection and incorporation of various templates (See FIG. 1 for an example of different “stories”).

In general, a picture or image is mapped into a 2D or 3D space. Overlaid objects are then incorporated into the image environment. The objects are animated using templates that describe predefined motions and/or actions. Objects extracted from the original picture or image may be made to interact with the overlaid objects associated with the templates. In this sense, the templates are “stories” that express which objects from the original image should be used, which objects should be added to the original image, and how these objects should be animated. The templates are applied by means of an automatic (or semi-automatic, user-assisted) mapping between the original image and the 2D or 3D template environment.

In one exemplary embodiment, the present invention provides a method for converting an image into an animated image or video, comprising: receiving the image from a user via an electronic device; applying a selected template to the image, wherein the selected template imparts selected portions of the image with motion or overlays selected objects on the image, thereby providing an animated image or video; and displaying the animated image or video to the user via the electronic device. The applying the selected template to the image is performed by software resident on the electronic device or remote from the electronic device. The electronic device comprises one of a personal computer (PC), a tablet computer, a smartphone, a web access device, and a cloud access device. Optionally, the selected template comprises a plurality of templates that form a “story.” The applying the selected template to the image comprises identifying one or more key features in the image. The applying the selected template to the image also comprises extracting one or more key features from the image. The applying the selected template to the image further comprises manipulating one or more key features from the image. The applying the selected template to the image still further comprises inserting the one or more manipulated key features into the image. Optionally the applying the selected template to the image comprises applying a mesh transformation to one or more parts of the image. The image and the animated image or video are two dimensional or three dimensional.

In another exemplary embodiment, the present invention provides a system for converting an image into an animated image or video, comprising: one or more processors operating software executing instructions configured to: receive the image from a user via an electronic device; apply a selected template to the image, wherein the selected template imparts selected portions of the image with motion or overlays selected objects on the image, thereby providing an animated image or video; and display the animated image or video to the user via the electronic device. The applying the selected template to the image is performed by software resident on the electronic device or remote from the electronic device. The electronic device comprises one of a personal computer (PC), a tablet computer, a smartphone, a web access device, and a cloud access device. Optionally, the selected template comprises a plurality of templates that form a “story.” The applying the selected template to the image comprises identifying one or more key features in the image. The applying the selected template to the image also comprises extracting one or more key features from the image. The applying the selected template to the image further comprises manipulating one or more key features from the image. The applying the selected template to the image still further comprises inserting the one or more manipulated key features into the image. Optionally the applying the selected template to the image comprises applying a mesh transformation to one or more parts of the image. The image and the animated image or video are two dimensional or three dimensional.

### BRIEF DESCRIPTION OF THE DRAWINGS

The present invention is illustrated and described herein with reference to the various drawings, in which like reference numbers are used to denote like system components/method steps, as appropriate, and in which:

FIG. 1 illustrates a plurality of exemplary storyboards that may be used in conjunction with the systems and methods of the present invention;

FIG. 2 illustrates one exemplary embodiment of the image animation process of the present invention;

FIG. 3 illustrates one exemplary embodiment of the image animation architecture of the present invention;

FIG. 4 illustrates one exemplary embodiment of the finite state machine—transitions/states diagram of the present invention;

FIG. 5 illustrates exemplary automatically detected face markers utilized by the systems and methods of the present invention;

FIG. 6 illustrates a completed image after automatically detected and extracted faces are processed by the systems and methods of the present invention;

FIG. 7 illustrates one exemplary embodiment of the mapping of a template to an image in accordance with the systems and methods of the present invention;

FIG. 8 illustrates an exemplary mesh for facial texture mapping and animation in accordance with the systems and methods of the present invention; and

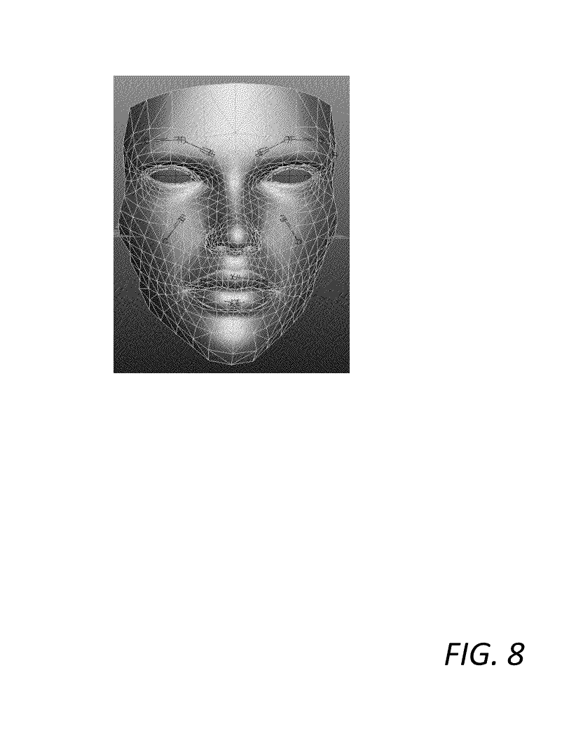

FIG. 9 illustrates the animation of a face in accordance with the systems and methods of the present invention.

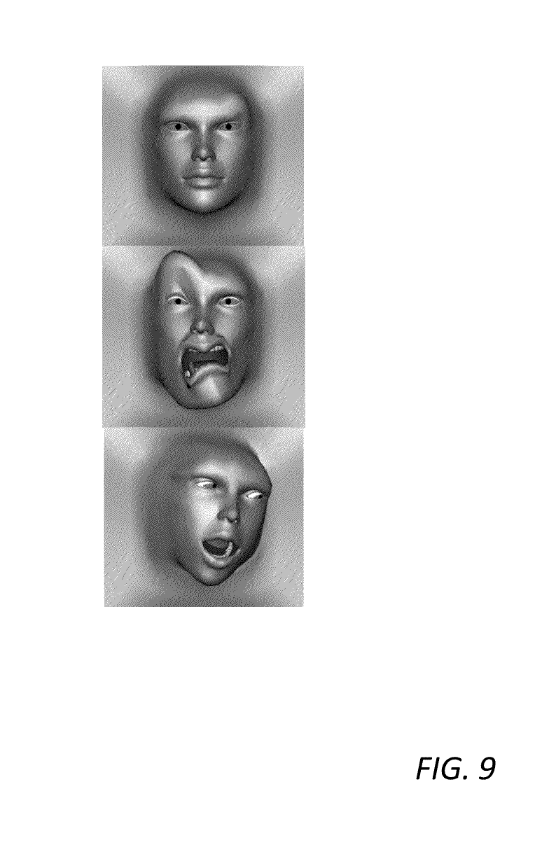

### DETAILED DESCRIPTION OF THE INVENTION

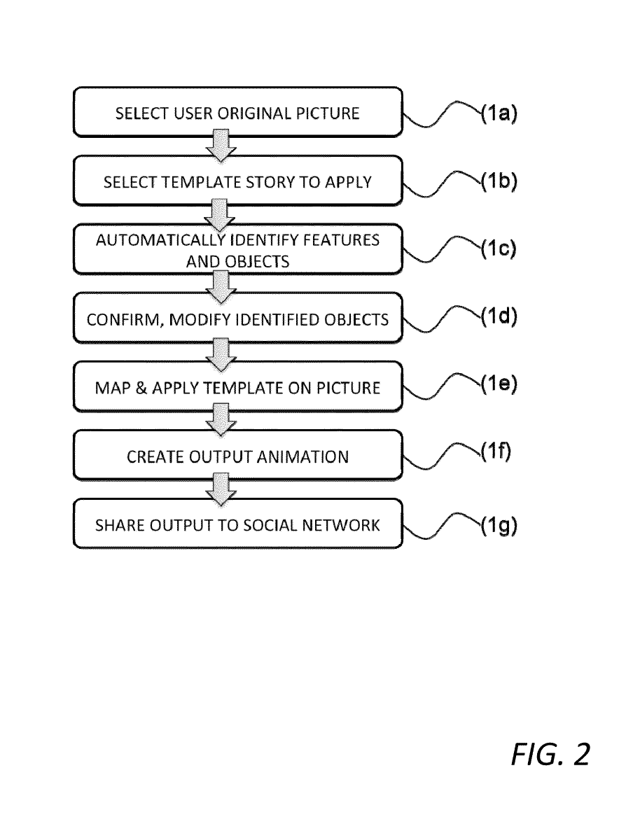

Referring now specifically to FIG. 2, in one exemplary embodiment, the overall process of the present invention includes the following basic steps:
1a) A user inputs his/her favorite picture from Facebook or the like, or from a storage medium, or directly taken from a device camera. The original picture may be in any graphical format (JPEG, GIF, TPEG, BMP, etc.) and 2D or 3D.
1b) The user selects the “story” he/she wants to apply to the original picture, that is the template, from a list of templates. These templates may describe a birthday party or a fun action story or the like.
1c) The application automatically identifies and recognizes the key objects, characters, and features of the picture that will be required for the template to be applied.
1d) A user interface enables the user to assess and/or modify, add, and/or remove these features and objects.
1e) The application automatically maps and applies the user-selected template to the user picture.
1f) As a result, a preview of the output (e.g., a video, an animated GIF, an interactive scene) is displayed to the user.
1g) The user visualizes and shares the final video through his/her favorite social networking means.

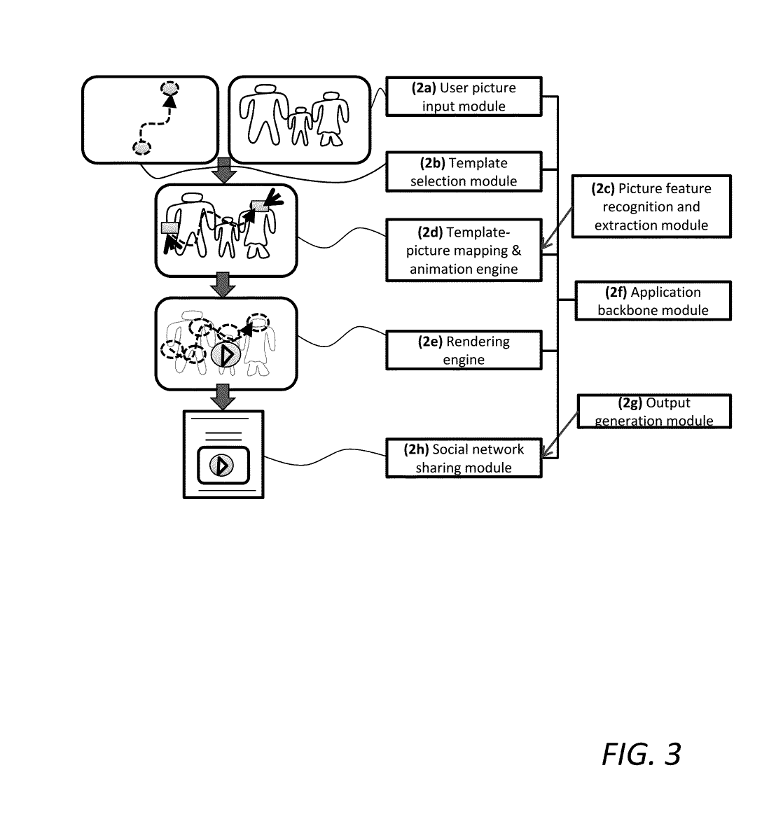

Referring now specifically to FIG. 3, in another exemplary embodiment, the system of the present invention comprises the following modules:
2a) User picture input module.
2b) Template selection module.
2c) Picture feature recognition and extraction module.
2d) Template-picture mapping and animation engine.
2e) Rendering engine.
2f) Application backbone module.
2g) Output generation module.
2h) Social network sharing module.

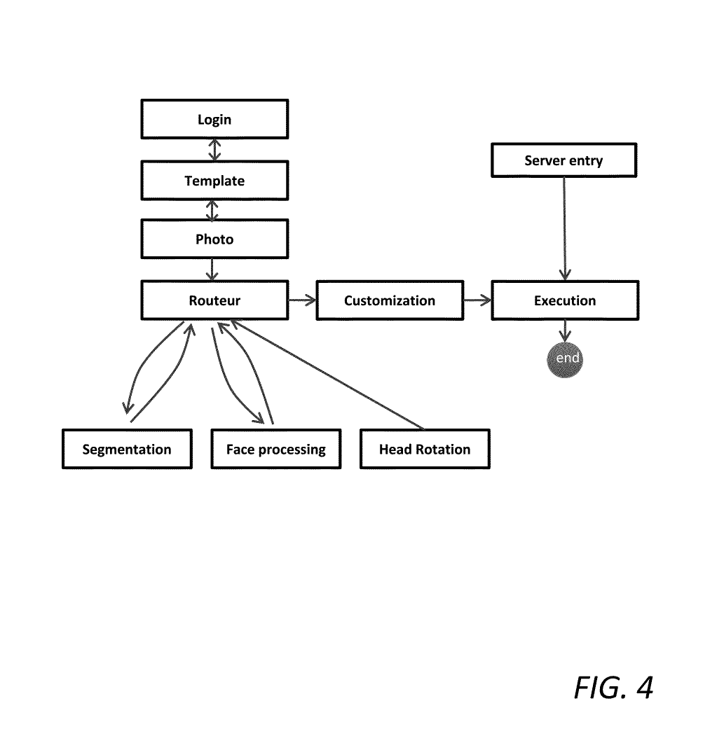

The application backbone module (2f) orchestrates the overall application hosted on a distributed server-client architecture, for example.
1. Finite-state machine. The orchestration is enabled through a finite-state machine (FSM) which controls the overall application behavior. This state machine is implemented so as to allow a same code base to run on both the client side (phone, PC Browser, etc.) and server side for the video generation itself within the rendering module (2g). FIG. 4 illustrates this state machine.
2. Distributed architecture. On the client side, this application backbone decouples the screen transition logic from the implementation of the other logic modules. Each state of the FSM may have an associated screen canvas allowing interaction with the user if needed by the linked modules. For instance, the face processing state is linked to the feature recognition module (2c) to perform a given automated detection, but it also has a screen linked to it in order to receive user manual corrections. Data to be transferred from one module to another module is handled by the state machine directly using a centralized container.
3. Scalability. On the state machine side, it is desirable to always handle present states (login, picture selection, etc.) and depending on the selected template, the state machine adapts itself to what is needed to be displayed to the user or which modules to call, by adapting the required states (e.g., a segmentation state may be optional for some templates). On the application side, the template selection is generated dynamically so as to enable dynamics in bringing more templates within the application from the template selection module (2b). The list of available templates is downloaded from a secure server, allowing just-in-time download of a template asset for communication with channel bandwidth optimization. This dynamic list also enables flexible business models that may be applied on some more sophisticated templates. On the server side, the same state machine is used, with a more limited number of possible states, however, due to the fact that on the server side there is no user interaction. In order to generate the video, the server instance receives from the client a serialized version of the centralized data container described above. The server instance deserializes this container and is able to replay the full animation and convert it into a video in an optimized way.

The user picture input module (2a) provides the ability to input a picture from several sources, that is browse local or cloud based storage (e.g., a SD card, an internal memory device, etc.) or directly provide the picture with the device (e.g., phone camera, etc.)

The template selection module (2b) enables the user to choose a reference “story” or animation that is applied to a user-selected picture. The template consists of a scene with specific properties and behaviors. Metadata specific to the application is used to describe the scene and the animation within the scene, such as overlays and graphical effects (e.g., fire, cake, etc.), objects behaviors (e.g., face animation, picture objects, such as legs or hands, associated texture motions, etc.) and properties of the objects (e.g., time dependent function, objects interaction, etc.).

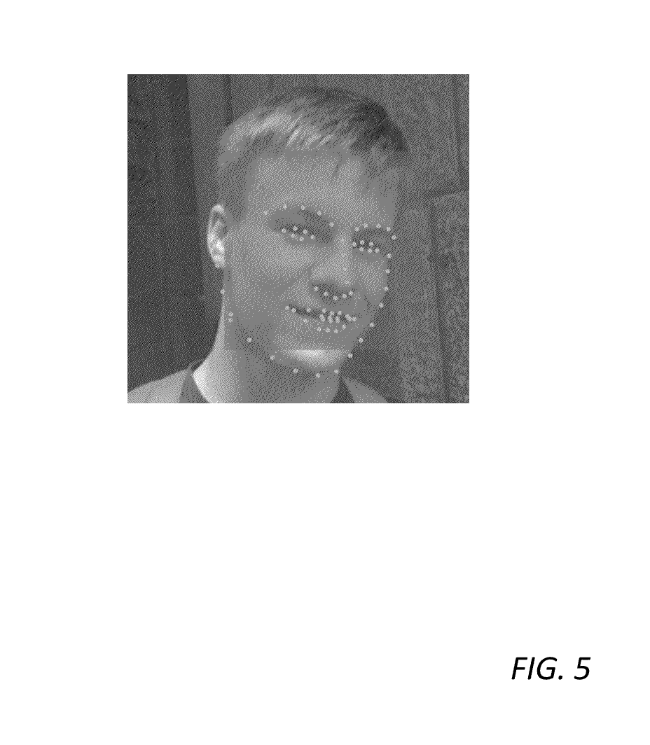

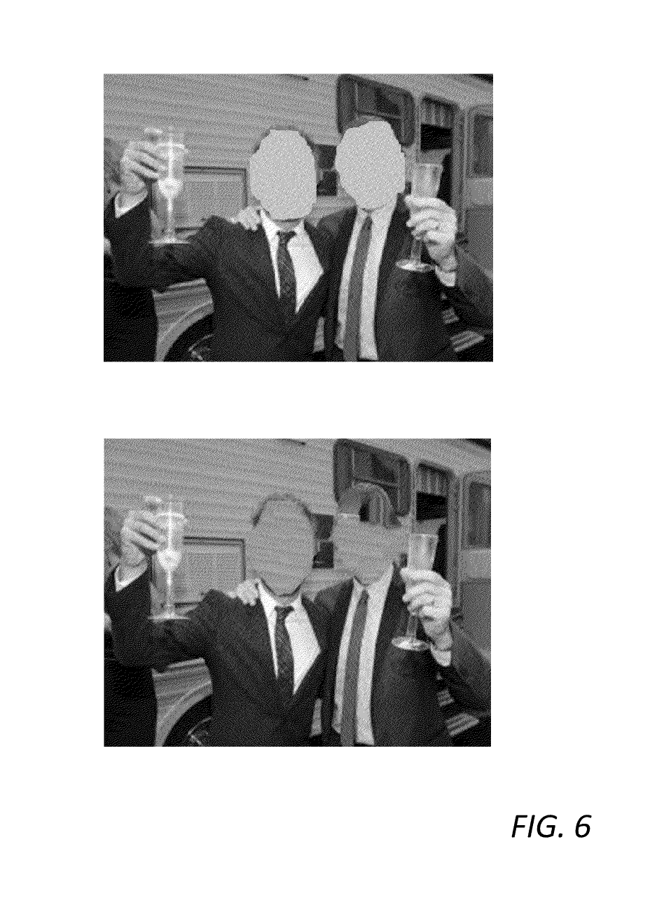

The picture feature recognition module (2c) is a computer vision module aimed at extracting from the user-input picture the features required by the designed template, e.g., a head that will smile or at which a tomato is thrown, a hand that will wave, etc. This module consists of several main image processing functions:
1. Feature recognition. A template matching algorithm runs on the picture in order to identify the feature specified within the template (e.g., person, head, arm, leg, etc.) as well as its key characteristics, such as size, orientation, and key points of interest. For the human face, a specific marker detector is implemented (see FIG. 5). A marker is a feature point on the face, which can be found in any other human face (around the eyes, mouth, nose, forefront, jaw, ears, etc.). The number and density of markers can vary depending on the template and the quality of the animation, which is targeted. In order to assist this process to make it robust, areas where features are located, or key markers (e.g., face markers, etc.) are confirmed through the user interface, and visible areas or points of interest that the user can resize or move are provided. The process of feature recognition becomes semi-automated when user input is required, otherwise it runs automatically.
2. Object extraction. Once a feature is identified, it might require segmentation, i.e., it is extracted from the picture in order to be manipulated as separate objects as defined by the template. This extraction is done through an image processing technique that is aimed at selecting the relevant pixels from the identified feature (e.g., head, hand, etc.). If necessary, the user can roughly mark regions in the image belonging to the object or the background in order to guide the automatic extraction.
3. Object inpainting. When an object or a person is extracted from the picture, the information of what was behind this object is not available. A specific module generates new pixels in the object region in order to reconstruct a coherent and plausible image that no longer contains the extracted object. FIG. 6 illustrates faces removed from the picture with the object extraction module and the picture that has been completed with inpainting.
4. Feature deformation. An animation template can also contain object specific 3D mesh templates (e.g., for a human face, a human body, arms, legs, etc.). With an image registration technique these meshes are fitted to the extracted object and textured according to the object. Consequently, the extracted objects can be freely animated and deformed.

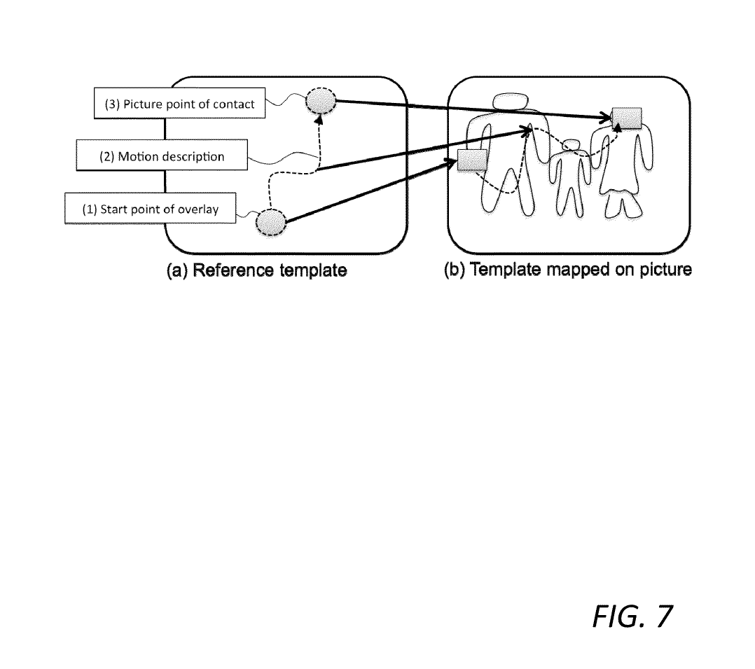

The mapping and animation module (2d) consists of the mapping process between the user picture and the selected template and the animation process that creates the personalized animated picture video (FIG. 7.).
1. Object mapping. In order to match the template features with their associated objects, behaviors, and properties to the user input picture extracted features, the matching mechanism requires two main elements:
   a. a semantic abstraction layer, wherein metadata are associated with overlays, behaviors, and properties and associated with the realities of the detected objects (automatically or semi automatically) of the picture.
   b. a transformation layer, to adapt the template defined behaviors and properties to the specifics of the picture. For instance, while the generic designer template illustrates a tomato thrown from a given hand on the left to a given head on the right, when matching this story to the user input picture, we may as well have a hand on the right throwing to a head on the left. The path that defines the behavior of a tomato in the template will therefore be very different related to the user input picture than related to the template path. Similarly, the given head or hand in the template may not have the same position, size, and/or orientation. Thus, the differences in the properties and behaviors between the template and the user input picture context require transformation in order to match them. Once features are matched, a mathematical transformation is calculated to move from the template referenced coordinate system to the user input picture coordinate system. Finally, the transformation consists of deforming the coordinate system. Such transformation is applied to all points within the rectangle. Thus, each of the properties and behaviors defined within the template may be applied to the user input picture and, more importantly, adapted to its specifics in terms of features, respective positions, intrinsic size, orientation, and position.
2. Face animation. In particular for human faces, the deformation of a template 3D mesh of a human head textured from a given input photograph, is showing an arbitrary human face, so it can be seamlessly displayed over this input photograph. The basic idea is to be able to define a single animation or deformation on this template head, and then apply it to a wide range of human faces from photographs.
   a. Fitting algorithm. An arbitrary picture of a human face which represents our target state is fed to the module. The coordinates of those same markers are automatically identified and located on the user input picture, using automatic computer vision techniques. Alternatively, such markers can simply be manually entered in the system through by the user. A simple rigid transformation technique might not suffice to match each marker automatically. In such a case, an alternative algorithm is used based on a more complex image registration technique to perform a better fitting using the first process for a good first approximation. This first rigid transform approximation is computed using procrustes analysis. This is a method for calculating the optimal rigid transformation matrix that minimizes the Root Mean Squared Deviation (RMSD) between two paired sets of points. The translation and the scale factor are simply computed from the centroids of each set, and the rotation is derived from the Singular Value Decomposition (SVD) of the correlation matrix.
   b. Given the rigid transform estimated during the previously described process, the target position of each template mesh marker in the final image is within a small window centered at the location of that marker in the UV parameterization, therefore a local non-rigid warp is used to interpolate the displacement needed for a perfect match. The interpolation is implemented using a linear combination of Gaussian Radial Basis Functions (RBF) centered at each marker. The bandwidth of each RBF is proportional to the distance to the nearest neighboring marker. The interpolated displacement is finally applied directly to the template 3D mesh vertices in order to obtain a seamless overlay.

Module (2e) renders the template effect applied onto the user selected picture. It implements a polygon rendering approach in order to optimize the computing process. To this conventional rendering method, the management of animated textures has been added. This may be a graphical object created within the designer template and imported within the user input picture scene and virtual items with animated texture (e.g., fire, explosion, etc.) and thus part of the output personalized animated picture rendered animation.

An animated output generation module (2f) converts the rendered frame into animated output (e.g., animated GIFs, videos in any format, etc.). This video module is an asynchronous backend kernel that orchestrates the video generation. This kernel creates required central processing unit (CPU) processes to perform required tasks that are activated by the application itself so as to enable the creation of animated pictures in a parallel and timely optimized fashion.

The Social network sharing module (2g) is a trivial social network implementation accessed by the application backend framework.

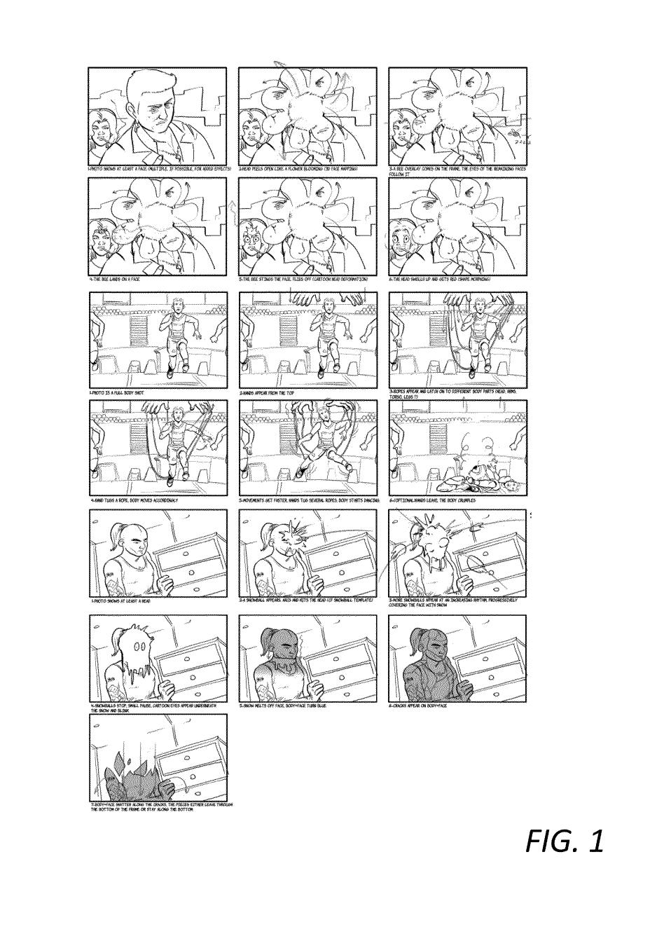

Thus, in various exemplary embodiments, the present invention provides an automated process that transforms still 2D or 3D pictures or images into personalized 2D or 3D animations or videos. Sound and/or other graphical objects may also be incorporated. Parts of the pictures or images are animated to create realistic or unrealistic motion (e.g., realistic human motion may be applied to an inanimate object or unrealistic motion may be applied to an animate object, among other possibilities). Various “stories” may be also applied to the pictures or images via the selection and incorporation of various templates (See FIG. 1 for an example of different “stories”).

In general, a picture or image is mapped into a 2D or 3D space. Overlaid objects are then incorporated into the image environment. The objects are animated using templates that describe predefined motions and/or actions. Objects extracted from the original picture or image may be made to interact with the overlaid objects associated with the templates. In this sense, the templates are “stories” that express which objects from the original image should be used, which objects should be added to the original image, and how these objects should be animated. The templates are applied by means of an automatic (or semi-automatic, user-assisted) mapping between the original image and the 2D or 3D template environment.

Although the present invention is illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims.

What is claimed is:

1. A method for converting an image into an animated image or video, comprising:
receiving the image from a user via an electronic device;
applying a selected template to the image, wherein the selected template imparts selected portions of the image with motion or overlays selected objects on the image, thereby providing an animated image or video; and
displaying the animated image or video to the user via the electronic device.

2. The method of claim 1, wherein the applying the selected template to the image is performed by software resident on the electronic device or remote from the electronic device.

3. The method of claim 1, wherein the electronic device comprises one of a personal computer (PC), a tablet computer, a smartphone, a web access device, and a cloud access device.

4. The method of claim 1, wherein the selected template comprises a plurality of templates that form a “story.”

5. The method of claim 1, wherein the applying the selected template to the image comprises identifying one or more key features in the image.

6. The method of claim 1, wherein the applying the selected template to the image comprises extracting one or more key features from the image.

7. The method of claim 1, wherein the applying the selected template to the image comprises manipulating one or more key features from the image.

8. The method of claim 7, wherein the applying the selected template to the image comprises inserting the one or more manipulated key features into the image.

9. The method of claim 1, wherein the applying the selected template to the image comprises applying a mesh transformation to one or more parts of the image.

10. The method of claim 1, wherein the image and the animated image or video are two dimensional or three dimensional.

11. A system for converting an image into an animated image or video, comprising:
one or more processors operating software executing instructions configured to:
receive the image from a user via an electronic device;
apply a selected template to the image, wherein the selected template imparts selected portions of the image with motion or overlays selected objects on the image, thereby providing an animated image or video; and
display the animated image or video to the user via the electronic device.

12. The system of claim 11, wherein the applying the selected template to the image is performed by software resident on the electronic device or remote from the electronic device.

13. The system of claim 11, wherein the electronic device comprises one of a personal computer (PC), a tablet computer, a smartphone, a web access device, and a cloud access device.

14. The system of claim 11, wherein the selected template comprises a plurality of templates that form a “story.”

15. The system of claim 11, wherein the applying the selected template to the image comprises identifying one or more key features in the image.

16. The system of claim 11, wherein the applying the selected template to the image comprises extracting one or more key features from the image.

17. The system of claim 11, wherein the applying the selected template to the image comprises manipulating one or more key features from the image.

18. The system of claim 17, wherein the applying the selected template to the image comprises inserting the one or more manipulated key features into the image.

19. The system of claim 11, wherein the applying the selected template to the image comprises applying a mesh transformation to one or more parts of the image.

20. The system of claim 11, wherein the image and the animated image or video are two dimensional or three dimensional.
